(19) United States
(12) Patent Application Publication
(10) Pub. No.: US 2011/0101953 A1
(43) Pub. Date: May 5, 2011

(54) Control Device and Switching Power Supply

(76) Inventors: Lan-Shan Cheng, Hsinchu City (TW); Chih-Yuan Hsieh, Hsinchu County (TW)

(21) Appl. No.: 12/641,298

(22) Filed: Dec. 17, 2009

(30) Foreign Application Priority Data
Oct. 29, 2009 (TW) 098136635

(51) Int. Cl. G05F 3/08

(52) U.S. Cl. 323/311

(57) ABSTRACT

A control device for a switching power supply includes an frequency-hopping oscillator for generating an oscillating signal and an indication signal, an SR flip flop for outputting a driving signal according to the oscillating signal and the indication signal, to control a primary winding of a transformer of the switching power supply, a comparator for comparing a current sense signal of the primary winding and a subtraction result, to output the comparison result to the SR flip flop, a ramp generator for generating ramp signals with time-varying slopes, and a subtraction unit for performing a subtraction operation on a feedback signal and the ramp signals, to generate the subtraction result for the comparator.

### BACKGROUND OF THE INVENTION

1. Field of the Invention

The present invention relates to a control device and switching power supply, and more particularly, to a control device and switching power supply capable of enhancing anti-interference ability and effectively maintaining system stability.

2. Description of the Prior Art

Flyback switching power supplies have merits such as high efficiency, low loss, small size and light weight, and thus have been widely used as power conversion devices in a variety of electronic products. Please refer to FIG. 1A, which is a schematic diagram of a conventional flyback switching power supply 10. The flyback switching power supply 10 is utilized for converting an alternating current (AC) input power Vac into a direct current (DC) electric power Vo_dc, and supplying or driving a load 100. The flyback switching power supply 10 mainly includes a controller 102, a transformer 104, a rectifying filter circuit 106, a feedback circuit 108, a switch Q_DRV and a resistor Rcs. Interior elements of the controller 102 include an oscillator 110, an SR flip flop 112 and a comparator 114 as shown in FIG. 1B. Operations of the flyback switching power supply 10 are well known by those skilled in the art. The following description and FIG. 2 take constant current as an example.

FIG. 2 is a schematic diagram of an inductive current IL, a feedback signal FB, a current sense signal CS, a driving signal NDRV and a load current Io shown in FIG. 1A and FIG. 1B. The inductive current IL is a current of a primary winding (with inductance characteristics) of the transformer 104. The feedback signal FB is an indication signal generated by the feedback circuit 108 according to the DC electric power Vo_dc. The current sense signal CS denotes magnitude of the inductive current in voltage form. The driving signal NDRV is utilized for controlling on/off of the switch Q_DRV. The load current Io is a current drained by the load 100. First, the oscillator 110 generates oscillating signals with a fixed frequency to a set terminal of the SR flip flop 112, such that the driving signal NDRV generated by the SR flip flop 112 turns on the switch QDRV with the same fixed frequency. After the switch Q_DRV is turned on, the inductive current IL starts to increase, as the current sense signal CS increases correspondingly. Since the current sense signal CS is coupled to a positive terminal of the comparator 114 (marked as +), and the feedback signal FB is coupled to a negative terminal (marked as −), when the value of the current sense signal CS increases to the value of the feedback signal FB, the comparator 114 outputs a logic “1” to a reset terminal of the SR flip flop 112. Thus, the SR flip flop 112 is reset and turns off the driving signal NDRV, and the primary inductance of the transformer 104 starts to discharge. Therefore, the inductive current IL is a repetitive triangle wave in a stable state.

However, the wave schematic diagrams shown in FIG. 2 are waveforms of related signals when the flyback switching power supply 10 is under ideal operating condition. In fact, there are some unideal characteristics of the flyback switching power supply 10 leading to effects such as Electromagnetic Interference (EMI), such that a source power or environment are interfered. Therefore, related specifications have defined the amount of tolerable EMI in different frequency bands for circuit designs.

### SUMMARY OF THE INVENTION

It is therefore an objective of the present invention to provide a control device and switching power supply.

The present invention discloses a control device for a switching power supply. The switching power supply includes a transformer, for supplying a direct current (DC) electric power. The control device includes an frequency-hopping oscillator, for generating an oscillating signal and an indication signal, a frequency of the oscillating signal switched among a plurality of frequencies, the indication signal indicating a variation condition of the frequency, an SR flip flop, including a set terminal coupled to the oscillating signal of the frequency-hopping oscillator, a reset terminal coupled to a comparison result, and an output terminal, for outputting a driving signal via the output terminal according to signals of the set terminal and the reset terminal, so as to control a primary winding of the transformer, a comparator, including a first signal terminal for receiving a current sense signal of the primary winding, a second signal terminal for receiving a subtraction result, and a third signal terminal coupled to the reset terminal of the SR flip flop, for comparing signals of the first signal terminal and the second signal terminal, and outputting the comparison result to the reset terminal of the SR flip flop via the third signal terminal, a ramp generator, for generating a ramp signal with a time-varying slope according to the indication signal, and a subtraction unit, for performing a subtraction operation on a feedback signal related to the DC electric power and the ramp signal, to generate the subtraction result for the second signal terminal of the comparator.

The present invention further discloses a switching power supply, for supplying a direct current (DC) electric power to a load, including a transformer, including a primary winding and a secondary winding, a resistor, for generating a current sense signal, a switch, coupled between the primary winding of the transformer and the resistor, for controlling a connection between the primary winding and the resistor according to a driving signal, a rectifying filter circuit, coupled between the secondary winding of the transformer and the load, a feedback circuit, for generating a feedback signal corresponding to a power reception condition of the load, and a control device. The control device includes an frequency-hopping oscillator, for generating an oscillating signal and an indication signal, a frequency of the oscillating signal switched among a plurality of frequencies, the indication signal indicating a variation condition of the frequency, an SR flip flop, including a set terminal coupled to the oscillating signal of the frequency-hopping oscillator, a reset terminal coupled to a comparison result, and an output terminal coupled to the switch, for outputting a driving signal via the output terminal according to signals of the set terminal and the reset terminal, a ramp generator, for generating a ramp signal with a time-varying slope according to the indication signal, and a subtraction unit, for performing a subtraction operation on the feedback signal and the ramp signal, to generate the subtraction result for the second signal terminal of the comparator.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a conventional flyback switching power supply.

FIG. 1B is a schematic diagram of a controller shown in FIG. 1A.

FIG. 2 is a schematic diagram of waveforms of related signals shown in FIG. 1A and FIG. 1B.

FIG. 3 is a schematic diagram of related signals when the flyback switching power supply operates at two distinct frequencies in ideal condition.

FIG. 4 is a schematic diagram of related signals when the flyback switching power supply operates at two distinct frequencies in practical condition.

FIG. 5 is a schematic diagram of related signals when the flyback switching power supply operates at two distinct frequencies in a discontinuous current mode.

FIG. 6 is a schematic diagram of a control device according to an embodiment of the present invention.

FIG. 7 is a schematic diagram of related signals when the controller of the flyback switching power supply shown in FIG. 1A is replaced by the control device shown in FIG. 6.

FIG. 8 and FIG. 9 are schematic diagrams of two ramp generators.

### DETAILED DESCRIPTION

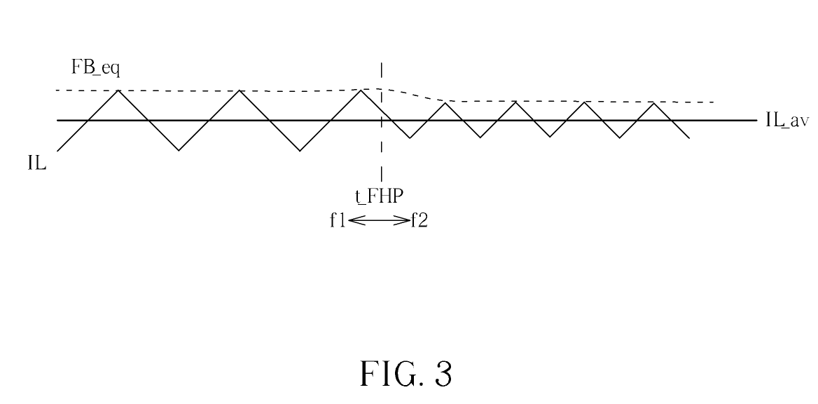

Generally, Electromagnetic Interference (EMI) energy is often concentrated within certain frequency bands under the same operating environment. Thus, in order to reduce unideal effects due to EMI, one improving method is to provide different oscillating frequencies, so as to adjust an operating frequency of the whole system, for reducing EMI effect. Please refer to FIG. 3, which is a schematic diagram of related signals when the flyback switching power supply 10 operates at two distinct frequencies. In order to clarify a variation condition of the inductive current IL, an equivalent current of the feedback signal FB (i.e. FB/Rcs) is denoted by a signal FB_eq in FIG. 3. In other words, FIG. 3 can be seen as an illustration that the feedback signal FB and the current sense signal CS are divided by the resistor Rcs. As can be seen from FIG. 3, the oscillator 110 increases an frequency from f1 to f2 at time t_FHP, while reduces amplitude of the feedback signal FB properly, such that an average current IL_av of the inductive current IL maintains constant.

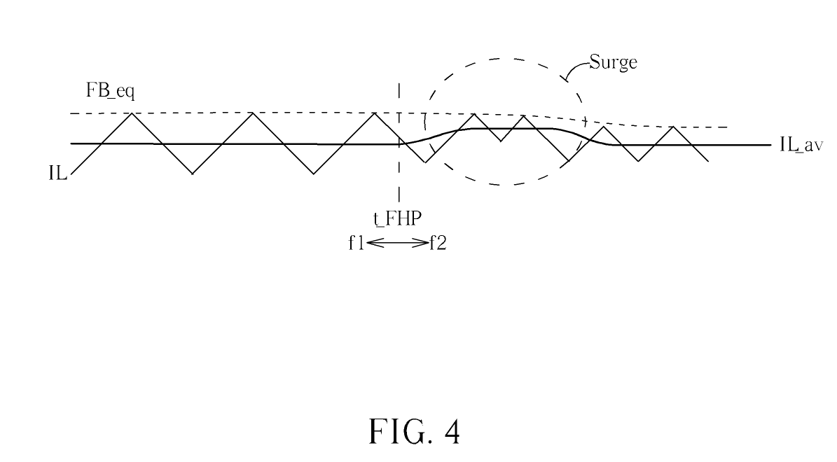

In FIG. 3, when the oscillating frequency of the oscillator 110 increases from f1 to f2, EMI generated by the flyback switching power supply 10 can be reduced due to a frequency variation. However, in practical, since the flyback switching power supply 10 only has limited frequency band, the feedback signal FB cannot change as soon as the frequency is switched. Thus, the inductive current IL has a surge or impulse when the frequency is switched as shown in FIG. 4. At this moment, the load current Io also has a corresponding surge. This phenomenon will continue until the feedback signal FB can follow.

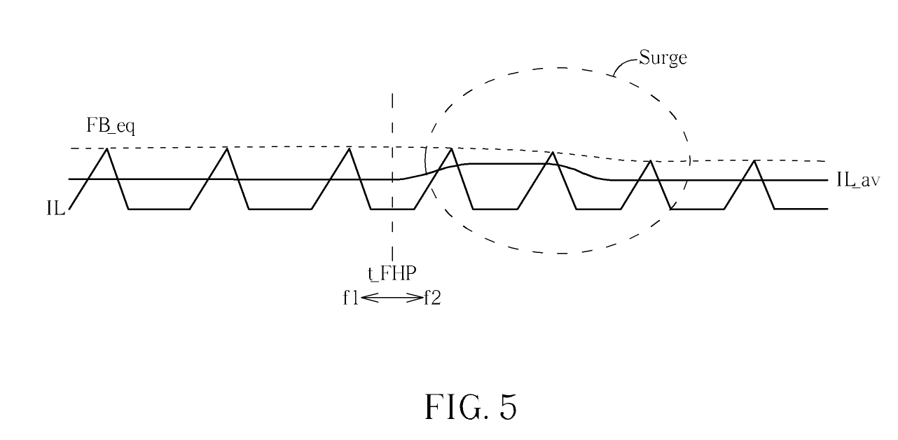

The above description takes a Continuous Current Mode (CCM) for example. Similarly, the same result can be derived in a Discontinuous Current Mode (DCM). For example, FIG. 5 is a schematic diagram of related signals when the flyback switching power supply 10 operates at two distinct frequencies in DCM. As can be seen from FIG. 5, in DCM, when the flyback switching power supply 10 increases a frequency from f1 to f2 at time t_FHP, since the feedback signal FB cannot immediately follow when the frequency is switched, the inductive current IL would have a surge.

Therefore, as can be seen from the above, no matter the controller 102 operates in CCM or DCM, when the operating frequency is switched, the flyback switching power supply 10 faces a surge issue, which reduces reliability and affects the operation of the load 100.

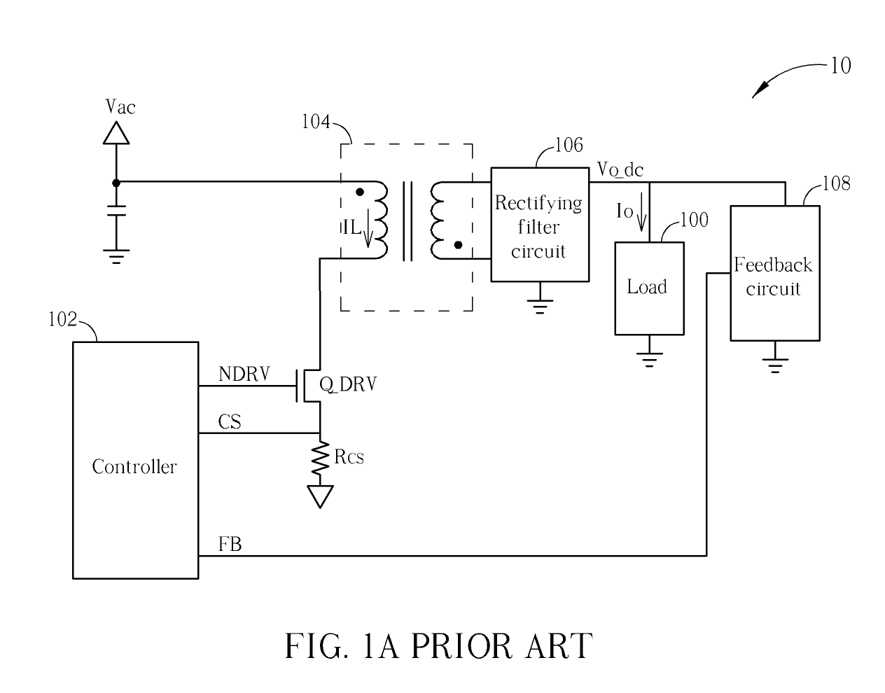

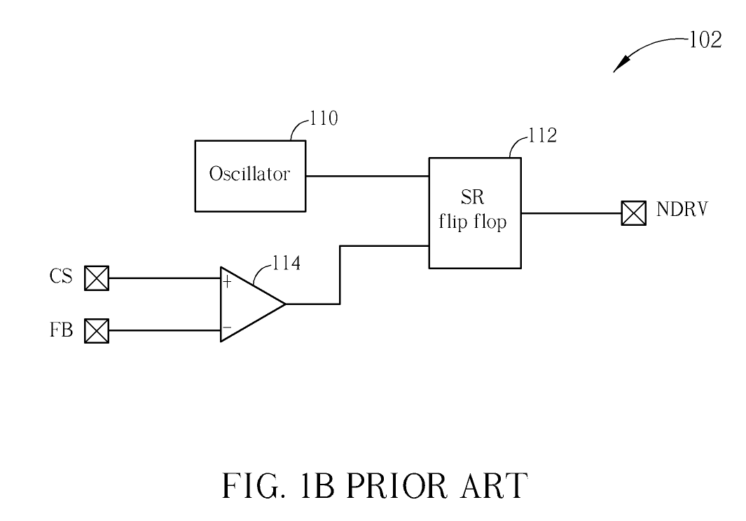

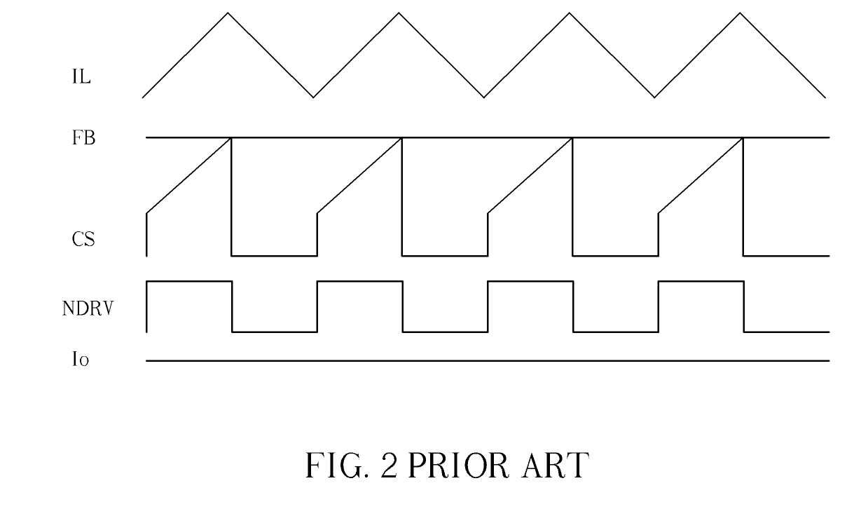

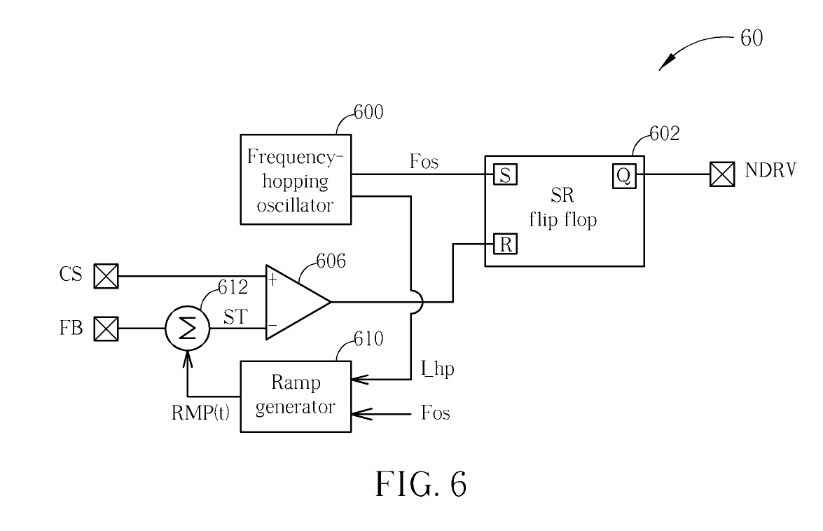

Please refer to FIG. 6, which is a schematic diagram of a control device 60 according to an embodiment of the present invention. The control device 60 is utilized in the flyback switching power supply 10 shown in FIG. 1A, for replacing the controller 102 to control the on/off of the switch QDRV, so as to further control magnitude of the DC electric power Vo_dc. The control device 60 includes a frequency-hopping oscillator 600, an SR flip flop 602, a comparator 606, a ramp generator 610 and a subtraction unit 612. By comparing FIG. 1B and FIG. 6, in contrast to the conventional controller 102, the ramp generator 610 and the subtraction unit 612 are added, and the oscillator 110 is replaced with the frequency-hopping oscillator 600 in the control device 60 of the present invention. Generally, operation principles of the control device 60 are similar to those of the controller 102. Both the control device 60 and the controller 102 output the driving signal NDRV according to the feedback signal FB and the current sense signal CS. Differences between the control device 60 and the controller 102 are: the control device 60 has a frequency-hopping function, and can adjust the feedback signal FB according to frequency-hopping conditions, to avoid the surge resulted from a lack of bandwidth.

In detail, the frequency-hopping oscillator 600 generates an oscillating signal Fos and an indication signal I_hp for a set terminal S of the SR flip flop 602 and the ramp generator 610 respectively. The ramp generator 610 outputs a ramp signal RMP(t) with a time-varying slope to the subtraction unit 612 according to the indication signal I_hp. The subtraction unit 612 calculates a subtraction result ST of the feedback signal FB minus the ramp signal RMP(t), and outputs the subtraction result ST to the comparator 606. The comparator 606 is utilized for comparing the current sense signal CS and the subtraction result ST. If the current sense signal CS in a positive terminal (marked as +) is higher than the subtraction result ST in a negative terminal, the comparator 606 outputs a logic “1”, or otherwise, outputs a logic “0”. A comparison result of the comparator 606 is further transferred to a reset terminal R of the SR flip flop 602, such that the driving signal NDRV outputted by the SR flip flop 602 become related to the ramp signal RMP(t) in the meantime.

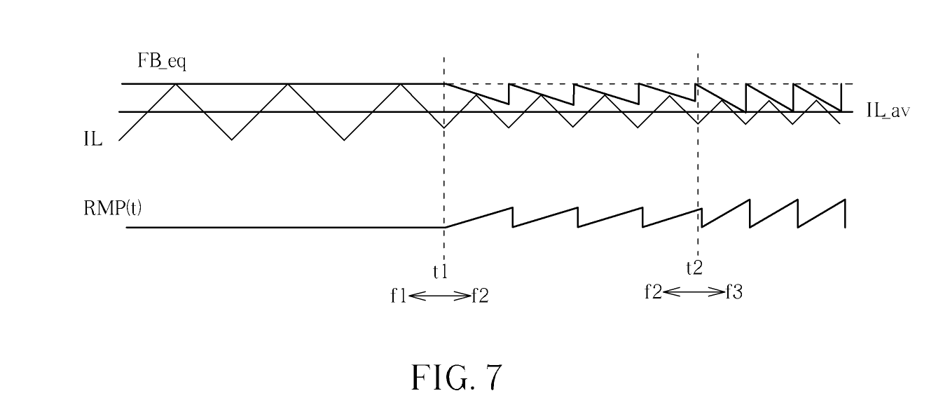

Therefore, as can be seen from the above, the control device 60 can switch the operating frequency among a plurality of frequencies, and properly adjust the feedback signal FB according to a frequency-hopping condition in the meantime, so as to avoid the surge resulted from a lack of bandwidth. For example, please refer to FIG. 7, which is a schematic diagram of related signals when the controller 102 of the flyback switching power supply 10 is replaced by the control device 60. As shown in FIG. 7, if a frequency of the oscillating signal Fos increases from f1 to f2 at time t1 and increases from f2 to f3 at time t2, a slope of the ramp signal RMP(t), generated by the ramp generator 610 according to the indication signal I_hp generated by the frequency-hopping oscillator 600, would increase by two stages. In other words, when the frequency of the oscillating signal Fos is switched, the subtraction result ST of the feedback signal FB minus the ramp signal RMP(t) changes accordingly, such that the value of the current sense signal CS (amplitude) increases to the value of the subtraction result ST in advance or in sequel. As the above description, if the positive terminal of the comparator 606 is greater than the negative terminal of the comparator 606, the comparator 606 would output the logic “1” to the reset terminal R of the SR flip flop 602. As a result, the higher the frequency of the oscillating signal Fos is, the deeper the saw tooth shape (related to the feedback signal FB minus the ramp signal RMP(t)) of the signal FB_eq (i.e. the equivalent current of the feedback signal FB) is. Thus, the amplitude of the inductive current IL touching the signal FB_eq is reduced. As a result, the surge generated due to limited system bandwidth is avoided, so as to keep the average current IL_av of the inductive current IL to a constant.

The control device 60 shown in FIG. 6 is utilized for replacing the controller 102 shown in FIG. 1A. The control device 60 utilizes a frequency-hopping method to avoid the unideal effects due to EMI, and utilizes the ramp signal with a time-varying slope, to avoid the surge due to limited system bandwidth. Noticeably, the control device 60 is only utilized for illustrating the spirit of the present invention, and those skilled in the art can make modifications or alterations accordingly. For example, a buffer can be added between the output terminal Q of the SR flip flop 602 and the switch QDRV, to avoid interference between the output terminal Q of the SR flip flop 602 and the switch QDRV. Furthermore, in the control device 60, realization of the ramp generator 610 is not limited to specific elements or circuits. Devices capable of outputting the ramp signal RMP(t) with a time-varying slope according to the indication signal I_hp can be applied in the present invention.

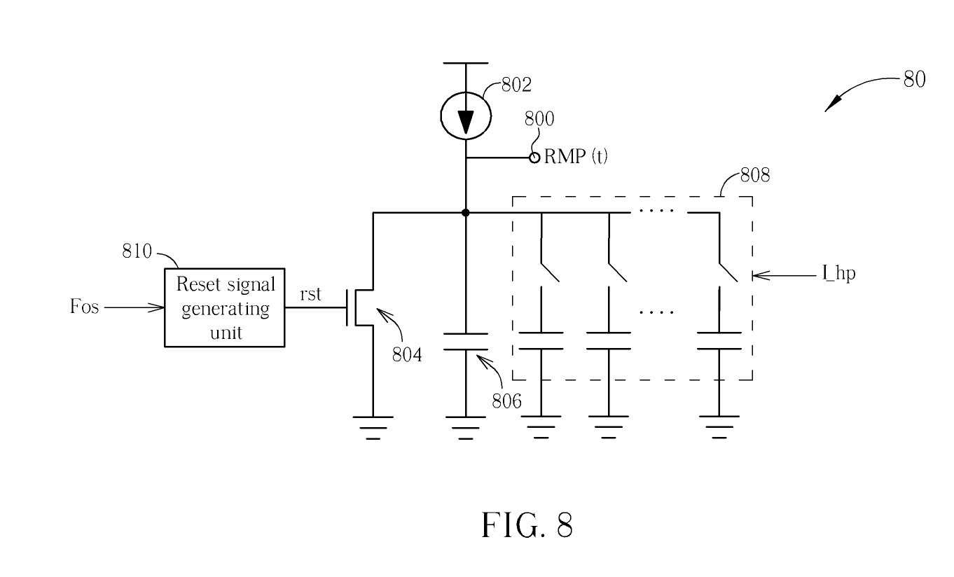

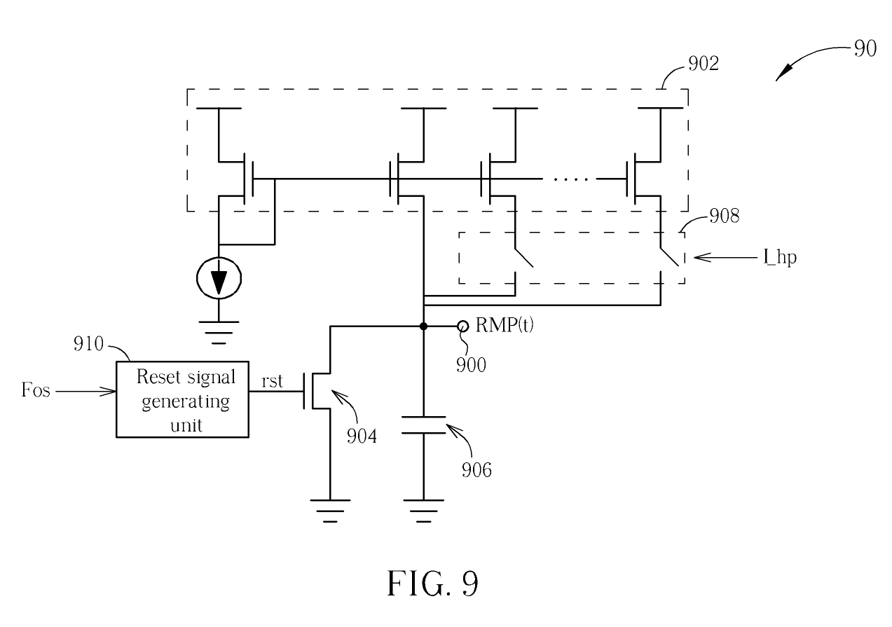

For example, please refer to FIG. 8 and FIG. 9, which are schematic diagrams of ramp generators 80 and 90, respectively. The ramp generators 80 and 90 can be utilized for realizing the ramp generator 610, to generate the ramp signal RMP(t) with a time-varying slope. In FIG. 8, the ramp generator 80 includes a ramp output terminal 800, a current generator 802, a reset switch 804, a basic capacitor 806, a slope adjustment module 808 and a reset signal generating unit 810. Connections between the above elements can be referred to FIG. 8, which are not narrated herein. The reset signal generating unit 810 preferably generates a reset signal rst according to the oscillating signal Fos and the indication signal I_hp, so as to control operations of the reset switch 804. The slope adjustment module 808 includes a plurality of switches and a plurality of capacitors, for determining an amount of capacitors connected to the ramp output terminal 800 according to the indication signal I_hp. Operations of the ramp generator 80 can be illustrated with FIG. 7 as follows. The frequency of the oscillating signal Fos is below a threshold before time t1, such that the reset signal rst generated by the reset signal generating unit 810 keeps the reset switch 804 on. Thus, a current generated by the current generator 802 flows through the reset switch 804 to a ground, instead of charging the basic capacitor 806. Then, the frequency of the oscillating signal Fos starts to increase from time t1, such that the reset signal rst generated by the reset signal generating unit 810 switches the reset switch 804 on/off according to the frequency of the oscillating signal Fos. Meanwhile, the slope adjustment module 808 would determine an amount of turned-on switches according to the indication signal I_hp. If the slope adjustment module 808 turns on less switches, the current generator 802 charges less capacitors as well. Thus, time constant is greater, so is the slope of the ramp signal RMP(t). Similarly, the frequency of the oscillating signal Fos increases again from time t2. Thus, the slope adjustment module 808 modifies the amount of turned-on switches according to the indication signal I_hp, such that the slope of the ramp signal RMP(t) is increased.

Furthermore, in FIG. 9, the ramp generator 90 includes a ramp output terminal 900, a current mirror module 902, a reset switch 904, a basic capacitor 906, a switch module 908 and a reset signal generating unit 910. Operations of the reset signal generating unit 910 are similar to those of the reset signal generating unit 810 shown in FIG. 8. The current mirror module 902 is a composite current mirror, for mirroring currents to the switch module 908. The switch module 908 includes a plurality of switches, for controlling switches on/off according to the indication signal I_hp, so as to determine magnitude of a current flowing into the basic capacitor 906 or the reset switch 904, and further control the slope of the ramp signal RMP(t). The operations of the ramp generator 90 are illustrated with FIG. 7 as follows. The frequency of the oscillating signal Fos is below a threshold before time t1, such that the reset signal rst generated by the reset signal generating unit 910 keeps the reset switch 904 on. Thus, a current generated by the current mirror module 902 flows through the reset switch 904 to a ground, instead of charging the basic capacitor 906. Then, the frequency of the oscillating signal Fos starts to increase from time t1, such that the reset signal rst generated by the reset signal generating unit 910 switches the reset switch 904 on/off according to the frequency of the oscillating signal Fos. Meanwhile, the switch module 908 would determine an amount of turned-on switches according to the indication signal I_hp. If the switch module 908 turns on more switches, more current would flow into the basic capacitor 906, such that rising rate of a voltage of the basic capacitor 906 increases, i.e. enhancing the slope of the ramp signal RMP (t). Similarly, the frequency of the oscillating signal Fos increases again from time t2. Thus, the switch module 908 modifies the amount of turned-on switches according to the indication signal I_hp, such that the slope of the ramp signal RMP(t) is increased.

Noticeably, the exemplary embodiments shown in FIG. 8 and FIG. 9 are only utilized for illustrating possible realization of the ramp generator 610. Those skilled in the art can design a proper ramp generator according to practical requirement.

On the other hand, the above description takes CCM as example. As for the DCM operation, the present invention can effectively reduce the surge, so as to enhance system stability as well.

To sum up, the flyback switching power supply of the present invention utilizes a frequency-hopping method to avoid the unideal effects due to EMI, and utilizes the ramp signal with a time-varying slope to avoid the surge due to limited system bandwidth. Therefore, the present invention can enhance anti-interference ability of the flyback switching power supply, and effectively maintain system stability.

Those skilled in the art will readily observe that numerous modifications and alterations of the device and method may be made while retaining the teachings of the invention.

What is claimed is:

1. A control device for a switching power supply, the switching power supply comprising a transformer for supplying a direct current (DC) electric power, the control device comprising:
a frequency-hopping oscillator, for generating an oscillating signal with a frequency switched among a plurality of frequencies and an indication signal indicating a variation condition of the frequency;
an SR flip flop, comprising a set terminal coupled to the oscillating signal of the frequency-hopping oscillator, a reset terminal coupled to a comparison result, and an output terminal, for outputting a driving signal via the output terminal according to signals of the set terminal and the reset terminal, so as to control a primary winding of the transformer;
a comparator, comprising a first signal terminal for receiving a current sense signal of the primary winding, a second signal terminal for receiving a subtraction result, and a third signal terminal coupled to the reset terminal of the SR flip flop, for comparing signals of the first signal terminal and the second signal terminal, and outputting the comparison result to the reset terminal of the SR flip flop via the third signal terminal;
a ramp generator, for generating a ramp signal with a time-varying slope according to the indication signal; and
a subtraction unit, for performing a subtraction operation on a feedback signal related to the DC electric power and the ramp signal, to generate the subtraction result for the second signal terminal of the comparator.

2. The control device of claim 1, wherein the ramp generator comprises:
a ramp output terminal, coupled to the subtraction unit, for outputting the ramp signal;
a current generator, for outputting a current to the ramp output terminal;
a reset switch, coupled between the ramp output terminal and a ground, for controlling a connection between the ramp output terminal and the ground according to a reset signal;
a basic capacitor, coupled between the ramp output terminal and the ground, for determining a basic slope of the ramp signal; and
a slope adjustment module, coupled between the ramp output terminal and the ground, for adjusting the slope of the ramp signal according to the indication signal.

3. The control device of claim 2, wherein the slope adjustment module comprises:
a plurality of capacitors, coupled to the ground; and
a plurality of switches, coupled between the ramp output terminal and the plurality of capacitors, for controlling an amount of capacitors coupled to the ramp output terminal within the plurality of capacitors according to the indication signal.

4. The control device of claim 2, wherein the ramp generator further comprises a reset signal generating unit, for generating the reset signal according to the indication signal and the oscillating signal.

5. The control device of claim 1, wherein the ramp generator comprises:
a ramp output terminal, coupled to the subtraction unit, for outputting the ramp signal;
a current mirror module, for mirroring a current to a basic current terminal and a plurality of current terminals;
a reset switch, coupled between the ramp output terminal and a ground, for conducting a connection between the ramp output terminal and the ground according to a reset signal;
a basic capacitor, coupled between the ramp output terminal and the ground; and
a plurality of switches, coupled between the plurality of current terminals and the ramp output terminal, for controlling an amount of current terminals connected to the ramp output terminal within the plurality of current terminals according to the indication signal, to adjust the slope of the ramp signal.

6. The control device of claim 5, wherein the ramp generator further comprises a reset signal generating unit, for generating the reset signal according to the indication signal and the oscillating signal.

7. The control device of claim 1 further comprising a buffer, coupled to the output terminal of the SR flip flop.

8. A switching power supply, for supplying a direct current (DC) electric power to a load, comprising:
a transformer, comprising a primary winding and a secondary winding;
a resistor, for generating a current sense signal;
a switch, coupled between the primary winding of the transformer and the resistor, for controlling a connection between the primary winding and the resistor according to a driving signal;
a rectifying filter circuit, coupled between the secondary winding of the transformer and the load;
a feedback circuit, for generating a feedback signal corresponding to a power reception condition of the load; and
a control device, comprising:
a frequency-hopping oscillator, for generating an oscillating signal with a frequency switched among a plurality of frequencies and an indication signal indicating a variation condition of the frequency;
an SR flip flop, comprising a set terminal coupled to the oscillating signal of the frequency-hopping oscillator, a reset terminal coupled to a comparison result, and an output terminal coupled to the switch, for outputting the driving signal to the switch via the output terminal according to signals of the set terminal and the reset terminal;
a comparator, comprising a first signal terminal coupled between the switch and the resistor, a second signal terminal for receiving a subtraction result, and a third signal terminal coupled to the reset terminal of the SR flip flop, for comparing signals of the first signal terminal and the second signal terminal, and outputting the comparison result to the reset terminal of the SR flip flop via the third signal terminal;
a ramp generator, for generating a ramp signal with a time-varying slope according to the indication signal; and
a subtraction unit, for performing a subtraction operation on the feedback signal and the ramp signal, to generate the subtraction result for the second signal terminal of the comparator.

9. The switching power supply of claim 8, wherein the ramp generator comprises:
a ramp output terminal, coupled to the subtraction unit, for outputting the ramp signal;
a current generator, for outputting a current to the ramp output terminal;
a reset switch, coupled between the ramp output terminal and a ground, for controlling a connection between the ramp output terminal and the ground according to a reset signal;
a basic capacitor, coupled between the ramp output terminal and the ground, for determining a basic slope of the ramp signal; and
a slope adjustment module, coupled between the ramp output terminal and the ground, for adjusting the slope of the ramp signal according to the indication signal.

10. The switching power supply of claim 9, wherein the slope adjustment module comprises:
a plurality of capacitors, coupled to the ground; and
a plurality of switches, coupled between the ramp output terminal and the plurality of capacitors, for controlling an amount of capacitors coupled to the ramp output terminal within the plurality of capacitors according to the indication signal.

11. The switching power supply of claim 9, wherein the ramp generator further comprising a reset signal generating unit, for generating the reset signal according to the indication signal and the oscillating signal.

12. The switching power supply of claim 8, wherein the ramp generator comprises:
a ramp output terminal, coupled to the subtraction unit, for outputting the ramp signal;
a current mirror module, for mirroring a current to a basic current terminal and a plurality of current terminals;
a reset switch, coupled between the ramp output terminal and a ground, for conducting a connection between the ramp output terminal and the ground according to a reset signal;
a basic capacitor, coupled between the ramp output terminal and the ground; and
a switch module, coupled between the plurality of current terminals and the ramp output terminal, for controlling an amount of current terminals connected to the ramp output terminal with the plurality of current terminals according to the indication signal, to adjust the slope of the ramp signal.

13. The switching power supply of claim 12, wherein the ramp generator further comprises a reset signal generating unit, for generating the reset signal according to the indication signal and the oscillating signal.

14. The switching power supply of claim 8 further comprising a buffer, coupled to the output terminal of the SR flip flop.
